(19) United States
(12) Patent Application Publication
(10) Pub. No.: US 2007/0222856 A1
(43) Pub. Date: Sep. 27, 2007

(54) Portable Device for Viewing an Image and Associated Production Method

(76) Inventor: Patrick Roman Amaru, Bielefeld (DE)

Correspondence Address: BROOKS KUSHMAN P.C., 1000 TOWN CENTER, TWENTY-SECOND FLOOR, SOUTHFIELD, MI, 48075, US

(21) Appl. No.: 10/597,772

(22) PCT Filed: Dec. 22, 2004
(86) PCT No.: PCT/DE04/02819

§ 371 Date: Dec. 19, 2006

(30) Foreign Application Priority Data
Feb. 7, 2004 (DE) 10 2004 006 216.1
Feb. 27, 2004 (DE) 10 2004 010 101.9

(51) Int. Cl. H04N 13/04

(52) U.S. Cl. 348/53; 348/E13.001

(57) ABSTRACT

The invention relates to a portable device for viewing an image, in particular a stereo image, comprising a housing that is provided with an image, an optical unit and two viewing orifices. According to the invention, the image is generated by means of an electronically controllable display and the device is provided with elements that permit an external image data unit to supply the display with electronic image data by means of an image memory that is integrated into the housing and/or via an interface in a wireless manner. In addition, the device is equipped with a location determination unit for displaying corresponding mono or stereo images.

The invention relates to a portable device for viewing an image, in particular a stereo image, comprising a housing, in which an image, an optical unit and two viewer openings are provided.

The invention furthermore relates to a method for producing an image, in particular a stereo image pair, which is generated in a portable housing.

DE 43 35 899 A1 discloses a portable device for viewing an image, two liquid crystal displays for stereoscopic image reproduction being provided in a housing of the device. The housing is formed as a helmet-like carrying part that is placed onto the viewer's head. The known device has a drive unit, by means of which the analog video signals from two video cameras that are usually fed in via a cable are digitized and provided to the displays with a frame frequency of 150 Hz. What is disadvantageous about the known device, which is associated with the field of portable virtual reality systems, is that two separate displays are required, with the result that the costs are relatively high. Moreover, the known device cannot be used autonomously, that is to say that a signal connection to a separate system, in particular an image generating device, is always required. Furthermore, such helmets are relatively unwieldy, with the result that spontaneous use in everyday situations is not possible for practical reasons.

DE 197 02 623 A1 discloses a portable device for viewing a stereo image pair, comprising a foldable cardboard housing, in which are introduced two rectangular image windows at which are mounted the two stereo photographic images of a stereo photographic image pair for stereoscopic viewing thereof. Two viewing openings with preferably integrated viewing lenses are provided, so that a viewer can view the stereo photographic image when the housing is in the unfolded state of use. This is a low-cost stereo photographic image viewer that only permits a single stereo photographic image to be displayed.

U.S. Pat. No. 2,313,562 discloses a portable device for viewing a stereo image pair, comprising a rigid housing, in which or on which an image, an optical unit and two viewer openings are accommodated or fitted. A slot is provided on one side of the housing and a stereo image transparency can be inserted through said slot. The inserted image transparency has two stereo image pairs, so that the desired three-dimensional effect occurs upon viewing it. What is disadvantageous about the known device is that in order to display a plurality of images, the outlay with regard to having the images ready and changing them is relatively great. This means that a traveler has to carry a large number of image transparencies.

It is an object of the present invention to develop a portable device for viewing an image in such a way that a large number of current images are provided for the viewing thereof conveniently and rapidly.

In order to achieve this object, the device according to the invention, in conjunction with the preamble of patent claim 1, is characterized in that the image is generated by means of an electronically drivable display, and in that means are provided in such a way that the electronic image data made available to the display are provided in an image memory integrated in the housing and/or from an external image data unit via an interface in a wireless manner.

The particular advantage of the device according to the invention is that the viewer can view a plurality of current images virtually at any desired location. The image data are either stored in an integrated digital image memory or are downloaded upon request from an external image data unit and are buffer-stored in the image memory.

According to a preferred embodiment of the invention in accordance with patent claim 2, an electronic control unit is integrated in the portable device, which electronic control unit drives the electronic display. The control unit may be formed as a microcontroller and/or as a graphics controller, the downloaded or stored image data being visualized in a conventional image format such as JPEG, for example, in the display. The control unit may be assigned a program memory, with the result that it is possible to employ image programs for processing or conditioning the image data. The display may be formed as a conventional liquid crystal display or as an organically based display (OLED). The display is preferably formed as a stereo image display, two display segments each being allocated different stereo image data. The invention forms an autonomously functioning portable image viewing unit which can be used variably and flexibly.

According to a development of the invention in accordance with patent claim 3, the optical unit comprises a lens and/or reflector arrangement, so that a sharp and/or magnified image can be viewed with the device having small dimensions. Since the display is formed as a self-luminous display, it is alternatively possible to dispense with a light guiding arrangement. In this case, the optical unit is merely formed by lenses or glasses integrated in the viewer openings.

According to a development of the invention in accordance with patent claim 4, the image data are provided from a central image data unit at a remote location and are downloaded into the image memory of the device according to the invention via the air interface. This advantageously enables current image data to be visualized rapidly. The image data may preferably be transmitted via a provider to a mobile telephone, from where they are forwarded to the portable device for example via an infrared interface or a Bluetooth connection.

According to a development of the invention in accordance with patent claim 5, the image data are calculated by means of a computational model. The model standard VLMR/X3D may be used in this case, in particular the altitude data of the local area or terrain being processed. This advantageously makes it possible to provide image data for relatively large local areas, and a relatively small memory requirement is involved. It is advantageously possible to calculate a stereo image change virtually in real time, so that variable image excerpts can be made available relatively rapidly. In particular, it is thereby possible to simplify zooming from a larger to a smaller local region area, or vice versa.

According to a development of the invention in accordance with patent claim 6, a location determination unit is integrated in the housing, so that the current location of the portable device or the viewer can be determined. In this way it is possible to identify or select image data which are dependent on the current location of the portable device or the viewer. These location-dependent image data can then be visualized in the display, so that the viewer acquires information about the environment directly in the vicinity of the sojourn location. The image data may be for example map data in two-dimensional or three-dimensional form. The location determination unit may contain for example a GPS receiver and a compass module.

According to a development of the invention in accordance with patent claim 7, the mobile telephone that can be brought into communication with the housing via an interface with the latter can also be used for determining the location of the viewer, the coordinate field in which mobile telephone reception with respect to a fixed base station is possible being determined. It is advantageously possible in this way to determine present location data which are dependent on the current location of the viewer and which simplify the provision of the image data.

According to a development of the invention in accordance with patent claim 8, the display is formed as a stereo image display having two display segments for displaying the stereo image data pairs. The stereo image display is assigned a graphics controller, so that a plurality of images can be generated in real time. This can advantageously be used when the viewer uses the portable device for orientation in a foreign environment. By pivoting the portable device about a vertical axis, different image data representing different streets or different sectors of the surrounding environment can then be visualized depending on the viewing direction of the viewer.

According to a development of the invention in accordance with patent claim 9, the image memory may be supplemented by plug-in additional image memories in the card format, so that different map material can be provided depending on the chosen location of the viewer.

It is furthermore an object of the invention to specify a method for producing an image, thereby making it possible to provide image data about the current location of the viewer.

In order to achieve this object, the invention, in conjunction with the preamble of patent claim 12, is characterized in that means are provided in such a way that, from the current location of the housing, images identifying the environment thereof are provided in an electronic display.

The particular advantage of the method according to the invention is that the viewer is afforded the possibility that images are provided depending on the current sojourn location and enable orientation for said viewer in a foreign environment.

According to a preferred embodiment of the method according to the invention in accordance with claim 13, an integrated location determination unit makes it possible to ascertain the current sojourn location of the viewer, so that the corresponding image data about the environment in the immediate vicinity thereof can then be provided. Said image data can be provided from a central image data unit via an air interface or from an image memory integrated in the housing.

According to an alternative development of the method according to the invention in accordance with patent claim 14, by means of an integrated control unit it is also possible to provide arbitrary images for visualization which are dependent on the viewer's predefinition. By way of example, the viewer may download images from a central image data unit which identify the desired destination location.

An exemplary embodiment of the invention is explained in more detail below with reference to the drawings.

In the figures:

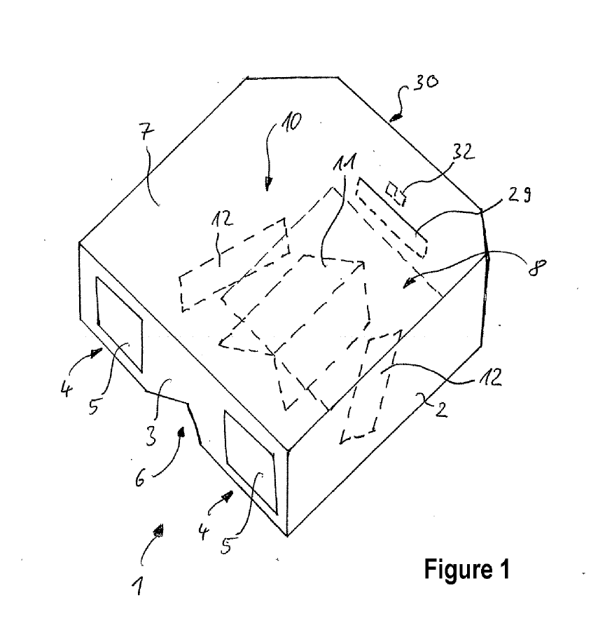

FIG. 1 shows a schematic perspective view of a portable device from above,

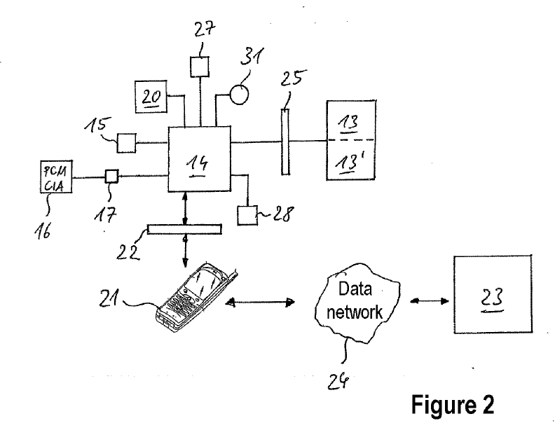

FIG. 2 shows a block diagram of electronic components of the portable device,

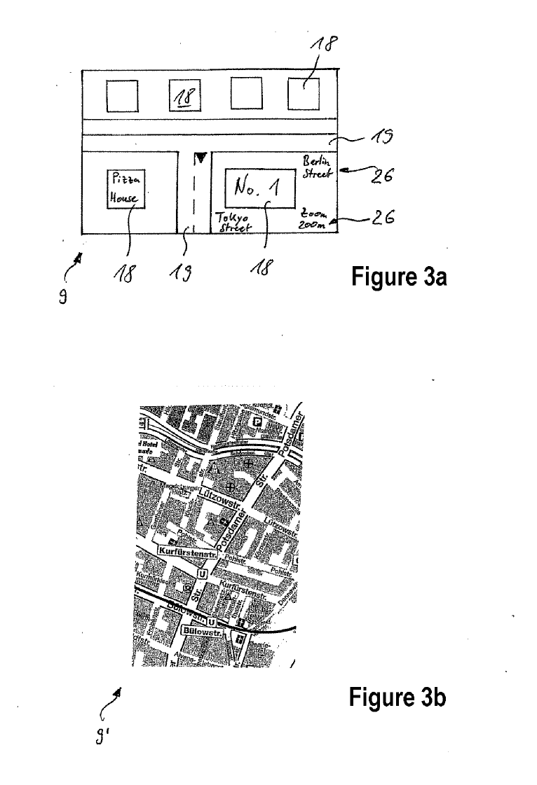

FIG. 3a shows a three-dimensional stereo image visualized in a display, and

FIG. 3b shows a two-dimensional image displayed in the display.

A portable device 1 in accordance with FIG. 1 is preferably used for viewers staying as business persons or tourists in a foreign environment, in particular in a foreign country. The portable device 1 may serve for orientation and for pictorial information in the new environment.

The portable device 1 has a rigid housing 2 corresponding to the dimensions of the portable device known from U.S. Pat. No. 2,313,562. The housing 2 has two viewing openings 4 on a narrow front side 3, a lens 5 (sheet of glass) being arranged in each of said openings. In order to comfortably put the front side 3 with the viewing lenses 5 up to the viewer's eyes, a nose cutout 6 is formed on an underside of the housing 2 adjacent to the front side 3.

The housing 2, which is formed essentially in parallelepipedal fashion, furthermore has a wide top side 7 extending essentially perpendicular to the front side 3. The top side 7 has on the inner side an electronic display 8, which serves for displaying an image 9, 9′ according to FIGS. 3a and 3b.

An optical unit 10 comprises, besides the viewing lenses 5, firstly inner mirrors 11 arranged in house roof fashion and secondly outer mirrors 12 for guiding the image rays emitted by the display 8 to the viewing lenses 5. The arrangement of the mirrors 11, 12 essentially corresponds to the arrangement of the mirrors represented in U.S. Pat. No. 2,313,562. This enables a display area that is large measured by the dimensioning of the housing 2 to be visualized in a relatively space-saving manner.

The display 8 is formed as a stereo image display and has two display segments 13, 13′, in each of which a stereo image of a stereo image pair are displayed in a manner oriented horizontally and vertically with respect to one another according to the laws of stereoscopy. By way of example, a three-dimensional stereo image 9 in accordance with FIG. 3a may be displayed, representing a pictorial plan view of part of a city or an excerpt of streets at a predetermined level with a 3D effect. The stereo display 8 may be formed from a single liquid crystal display or an organically based display, in the case of which the individual elements of the display can be driven differently according to the stereoscopic image data.

An electronic control unit 14 having a microcontroller or a central processor unit is provided for the processing of the image data and driving of the display 8. The stereoscopic or non-stereoscopic image data may be stored in an image memory 15 (EEPROM). As an alternative, the image data may also be stored in a plug-in card 16 (PCMCIA), it being possible for the plug-in card 16 to be connected to the control unit 14 a conventional card interface 17. Further image data exceeding the capacity of the image memory 15 can be made available in this way. Said image data may be dependent on predetermined locations, such as, for example, cities of Tokyo, Singapore, Hong Kong, etc.

The image data may be embodied, on the one hand, as three-dimensional stereoscopic image data, so that the viewer acquires a spatial impression of the displayed location. The image may be for example the visualization of a photograph of the location and may be present in a conventional image format such as, for example, JPEG format or the like. On the other hand, the image data may also be formed by two-dimensional map data, corresponding to an excerpt 9′ illustrated in FIG. 3b, which are offered as a road map by commercial providers.

The stereo image 9 in accordance with FIG. 3a gives the viewer a spatial impression of, for example, his current sojourn location since the corresponding environment is displayed from above at a predetermined height (for example 200 m). He can thus rapidly and easily identify distinctive buildings 18, which are represented schematically here as high-rise buildings, and streets 19 on account of their dimensions or course.

The invention enables the viewer to acquire, in particular, the pictorial representation of his current sojourn location or the environment in the vicinity of his sojourn location. For this purpose, the housing 2 contains a location determination unit 20, which may be formed as a magnetic sensor or as a compass for determining direction or for orientation of the device. The horizontal component of an orientation vector of the device oriented in three-dimensional space can thereby be determined relatively accurately. An inclination sensor may be integrated into the location determination unit 20 in order to determine the vertical component of the orientation vector. In conjunction with a mobile telephone 21 belonging to the viewer, the location data to be made available can be restricted to a coordinate field which is detected by a base station of the GSM network and in which the mobile telephone 21 is situated. As an alternative to this, a GPS receiver may also be integrated in the housing, with the result that it is not necessary to use the wireless interface (Bluetooth) 22 for communication with the mobile telephone 21.

Depending on the current sojourn location of the viewer or the housing 2, correspondingly predetermined image data can then be called up either from the image memory 15 or from the plug-in card 16 or from a central image data unit 23. The central image data unit 23 may be coupled to a mobile radio provider, so that the image data can be transmitted to the mobile telephone 21 via a data network 24 (GPRS, UMTS). After the coding of the image data in the mobile telephone 21, said image data can be provided to the control unit 14 via the Bluetooth interface 21. By means of a separate graphics controller 25, the image data in the stereo format can then be forwarded to the stereo image display 8, if appropriate in real time, for the visualization of the image 9 imparting a spatial impression. This also makes it possible to generate an image sequence preferably in a manner dependent on the orientation of the housing. In this case, the location determination unit 20 also supplies direction data, so that images or image sequences can be generated in a manner dependent on the viewing direction of the viewer.

It should be noted that the image 9 may have been conditioned in the central image data unit 23. It is possible, by way of example, to specify additional information 26, such as, by way of example, the height indication 200 m or street names. This additional information 26 may be inserted and lead to an increased information content in the image 9.

Moreover, the control unit 14 may also be assigned a program memory 27, by means of which image data programs can be called up.

A power supply unit 28, which may be formed as a battery or as a fuel cell, is provided as the voltage source 28 for the electronic components of the housing 2.

The control unit 14 and also the other electronic components may preferably be positioned as a compact structural unit 29 in the form of a logic board on a rear side 30 of the housing 2. The logic board 29 may preferably be positioned on an underside of the housing 2 or on a rear side 30 of the housing 2.

In addition, a microphone 31 may be integrated in the housing 2, so that voice commands can be input and processed further within the logic board. The voice commands may serve for selection control of the images 9, 9′.

An on-off switch 32, by means of which the electronic unit can be switched on and off, is provided on the rear side 30 of the housing 2.

By means of the voice command, the viewer can specify for example the height from which the image 9 is displayed in the display 8. By way of example, by means of the command “Zoom 200 meters”, he can request the image representing the current sojourn location within a predetermined radius at a height of 200 m. As described above, the image data can be provided either from an integrated image memory 15, 16 or from a central image data unit 23 by means of a data network. The control unit 14 enables the automatic selection of the corresponding image taking account of the current location data supplied by the location determination unit 20.

As an alternative, it is also possible to select arbitrary image data by means of a predetermined location excerpt.

According to an alternative embodiment (not illustrated), it is also possible for two displays to be provided instead of a single display. In this case, the optical unit 10 is reduced by the inner and outer mirrors 11, 12.

1. A portable device for viewing an image, in particular a stereo image, comprising a housing, in which an image, an optical unit and two viewer openings are provided, characterized in that the image is generated by means of an electronically drivable display, and in that means are provided in such a way that the electronic image data made available to the display are provided in an image memory integrated in the housing and/or from an external image data unit via an interface in a wireless manner.

2. The device as claimed in claim 1, characterized in that an electronic control unit is provided for driving the display.

3. The device as claimed in claim 1, characterized in that the optical unit comprises a lens and/or reflector arrangement in such a way that the image displayed by the display is magnified and/or imaged sharply.

4. The device as claimed in claim 1, characterized in that the image data can be downloaded from the central image data unit (23) via the air interface if appropriate with inclusion of a mobile telephone (21).

5. The device as claimed in claim 1, characterized in that the image data can be calculated by means of a computational model, in particular one according to the VRML/X3D standard.

6. The device as claimed in claim 1, characterized in that a location determination unit is accommodated in the housing in such a way that, depending on the location of the housing or the viewer, the display can be assigned an image corresponding to the location of the housing or the viewer.

7. The device as claimed in claim 1, characterized in that the coordinate fields detected by a base station in which the mobile telephone is situated can be used for determining the location of the viewer.

8. The device as claimed in claim 1, characterized in that the display is formed as a stereo image display having two display segments, and in that means are provided in such a way that stereo images are generated continuously in real time as an image sequence depending on the orientation of a compass integrated in the housing at the viewer's location.

9. The device as claimed in claim 1, characterized in that the image memory is formed as a plug-in card.

10. The device as claimed in claim 1, characterized in that the compass is formed as a magnetic sensor for determining the horizontal component of an orientation vector.

11. The device as claimed in claim 1, characterized in that an inclination sensor is formed for determining the vertical component of the orientation vector.

12. A method for producing an image, in particular a stereo image, which is generated in a portable housing, characterized in that means are provided in such a way that, from the current location of the housing, images identifying the environment thereof are provided in an electronic display.

13. The method as claimed in claim 12, characterized in that the current location is determined by means of a location determination unit integrated in the housing, and in that the images identifying the current location are then downloaded from a central image data unit via the air interface.

14. The method as claimed in claim 12, characterized in that images of a predeterminable location are provided by means of an integrated control unit.
